(19) United States
(12) Patent Application Publication
(10) Pub. No.: US 2006/0049261 A1
(43) Pub. Date: Mar. 9, 2006

(54) Method and apparatus for operating bar-code systems

(76) Inventor: Stefan Stadtler, Nurnberg (DE)

Correspondence Address: BRINKS HOFER GILSON & LIONE, P.O. BOX 10395, CHICAGO, IL, 60610, US

(21) Appl. No.: 11/212,157

(22) Filed: Aug. 26, 2005

(30) Foreign Application Priority Data
Sep. 1, 2004 (DE) 10 2004 042 317.2

(51) Int. Cl. G06K 7/10

(52) U.S. Cl. 235/462.15

(57) ABSTRACT

A method is provided for operating a bar-code system. A system has a screen that displays a graphical user interface that contains at least one control element. The method selects the control element to trigger an associated control command. The control element is a bar code that corresponds to the associated control command. The selection of the control element is performed when a bar-code reader reads in the corresponding bar- code from the graphical user interface, and the corresponding control command is generated and communicated to a device controller.

### FIELD

The present embodiments relate, in general, to bar-code computer systems, and in particular, to a method and an apparatus for operating a bar code supported system. The system is understood to be a computer-controlled machine, or an individual computer.

### BACKGROUND

For inputting control commands, computerized systems typically have one or more manually operated input devices, such as a keyboard and/or a position-inputting device such as a mouse, touchpad, joystick, track-point, trackball, tablet, or the like. In order to assign control functions to such an input device in a flexible, intuitive way, the user or operator is often, via a screen, shown or offered a graphical user surface or interface, A number of operator control elements, such as virtual keys, linear regulators, boxes to check, and so forth are shown or displayed on the screen. Each operator control element is assigned one control command (optionally configurable via associated arguments), which is tripped or triggered when the user selects the applicable operator control element. This selection is conventionally done by clicking on the operator control element using the position-inputting device, in the case of a touch screen by touching the operator control element with the finger, or by inputting specified key combinations on a keyboard. However, for inputting values and for inputting an identification code for an object to be registered, a bar code is typically used. Such bar code is generally placed on a stick-on label or the like in the form of printing on the object to be registered. Via a commercially available bar-code reader, such bar-code can be “read in”, or in other words acquired, identified, and converted into a value, for example in the form of binary data, text data, etc., usable or processable via electronic data processing.

### BRIEF SUMMARY

The present embodiments are defined by the appended claims. This summary describes some aspects of the present embodiments and should not be used to limit the claims.

A method operates a bar-code system, and an apparatus performs the disclosed method.

A user of a bar-code system or unit is also provided with a screen associated as an output device with the unit, a graphical user surface or interface which includes at least one operator control element. Concerning the at least one operator control element, a bar code is displayed on the screen. To select the operator control element, the user reads in the corresponding bar code from the screen, using a bar-code reader associated as an input device with the unit.

The bar-code reader, which for the sake of reaching the screen easily and comfortably, is a movable hand-guided device, and is operable or configured to generate a control command Based on the read-in bar code, the control command is linked with the bar-code and the associated operator control element, and this control command is communicated or forwarded to a device controller.

The proposed method is implemented in a device that is already equipped in the conventional way with a bar-code reader as an input device, such as an electronic cash register, any other kind of product registering system, an inventory system or the like.

The bar-code reader, as an input device, is adequate for complete operation of the unit. Thus, additional input devices such as a keyboard and a mouse can be dispensed with, or used only as optional extra equipment for the unit. While operating the unit, a change or switch between the bar-code reader and another input device is not needed, thus providing a relatively simple manipulation of the unit. This simple manipulation may also provide a substantially high operating reliability.

One illustrative and exemplary embodiment is described in further detail below with reference to, and in conjunction with the drawing.

### BRIEF DESCRIPTION OF SEVERAL VIEWS OF THE DRAWINGS

FIG. 1 schematically shows an apparatus for operating a unit, the apparatus has a screen for displaying a graphical user surface or interface that has a number of operator control elements, each of the operator control elements containing an associated bar code, and a movable bar-code reader for reading in the bar code shown on the screen.

### DETAILED DESCRIPTION

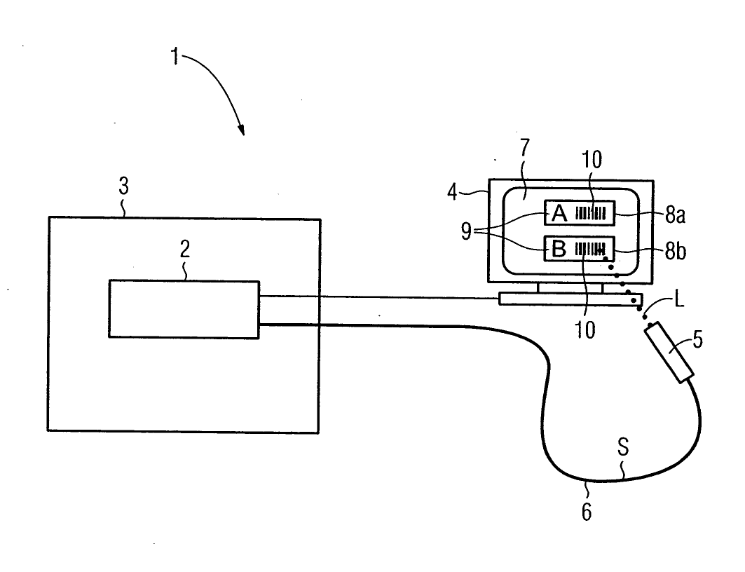

The apparatus 1 shown in FIG. 1 includes a device controller 2 for a unit 3. The unit 3 may be an electronic cash register. The device controller 2 is configured and operable as a component, such as a software component, of a computer that is integrated with the unit 3.

The device controller 2 is coupled or connected to a screen 4, for data output to a user. For inputting data, the device controller 2 is also coupled or connected to a bar-code reader 5. The bar-code reader 5 is configured and operable as a hand-guided device for movable use, which is coupled or connected to the device controller 2 via a cable segment 6 or a wireless connection. The cable segment 6 is configured such that, with the bar-code reader 5, the user can scan an arbitrary location on the screen 4.

The device controller 2 may be connected to other input devices (not further shown), such as a keyboard, a mouse, and so forth.

To enable the user to operate the unit 3, the device controller 2 generates a graphical user surface or a graphical user interface 7 and communicates or forwards it for display to the screen 4. The graphical user surface or interface 7 includes a number of operator control elements 8a, 8b. An operator control element 8a, 8b is defined as a graphically bounded area on the graphical user surface or interface 7 that is associated with a control command S for the device controller 2 and that can be selected by the user for tripping or triggering the control command S.

In the schematic diagram shown, the graphical user surface 7 includes the two operator control elements 8a and 8b; the operator control element 8a corresponds to a control command S schematically represented by the letter “A”, and the operator control element 8b corresponds to a control command S schematically represented by the letter “B”. In practice, “A” may stand for or represent positive acknowledgement of a preceding action (“OK”), while “B” may stand for or represent negative acknowledgement of the action (“abort”).

Each operator control element 8a, 8b includes an active field 9, in which the control command S associated with the operator control element 8a, 8b may be shown in alphanumeric form or as a picture symbol. Each operator control element 8a, 8b further includes a bar code 10 which supports or provides an unambiguous identification of the associated control command S. For selecting an operator control element 8a, 8b, the user aims the bar-code reader 5 at the screen 4 such that a reading beam L of the bar-code reader 5 sweeps over the bar-code 10 of the operator control element 8a, 8b to be selected. In the process, in a manner known per se, the bar-code reader 5 identifies or processes the bar code 10. The information encoded in the bar code 10 is converted into or generates a data signal corresponding to the control command S. This signal is delivered or communicated via the cable segment 6 to the device controller 2 for tripping or triggering an action corresponding to the control command S.

Optionally, the operator control elements 8a, 8b are configured, in the manner of conventional graphical user surfaces, as virtual keys, which can be selected using a mouse or the like. If the apparatus 1 also includes a keyboard as an input unit, then the operator control elements 8a, 8b can alternatively also be selected via an assigned key combination or shortcut.

1. A method for operating a bar-code system, the system having a screen that displays a graphical user interface containing at least one control element, the method comprising:
reading with a bar-code reader a bar code corresponding to a control command associated with the at least one control element, the bar code on the graphical user interface;
triggering the control command in response to the reading; and
communicating the triggered control command to a device controller.

2. An apparatus for operating a bar-code system, the apparatus comprising:
a screen to display a graphical user interface;
a bar-code reader to read in a bar-code displayed on the screen; and
a device controller to generate the graphical user interface and to receive a control command selected via the graphical user interface,
wherein the graphical user interface displays at least one operator control element that includes the bar-code, and
wherein the bar-code reader is operable to generate the control command, the control command associated with the operator control element read in by the bar code.
